(19) United States
(12) Patent Application Publication
(10) Pub. No.: US 2022/0091620 A1
(43) Pub. Date: Mar. 24, 2022

(54) CONTROL METHOD OF MOVABLE PLATFORM, MOVABLE PLATFORM, CONTROL TERMINAL, CONTROL DEVICE, CONTROL SYSTEM AND COMPUTER READABLE STORAGE MEDIUM

(71) Applicant: SZ DJI TECHNOLOGY CO., LTD., Shenzhen (CN)

(72) Inventors: Xianghua JIA, Shenzhen (CN); Guang YAN, Shenzhen (CN); Zongji HUANG, Shenzhen (CN)

(73) Assignee: SZ DJI TECHNOLOGY CO., LTD., Shenzhen (CN)

(21) Appl. No.: 17/541,266

(22) Filed: Dec. 3, 2021

Related U.S. Application Data
(63) Continuation of application No. PCT/CN2019/090062, filed on Jun. 5, 2019.

(51) Int. Cl. G05D 1/10; G01D 21/02; B64D 1/18; B64C 39/02

(52) U.S. Cl. CPC G05D 1/101; G01D 21/02; B64D 1/18; B64C 2201/141; B64C 2201/042; B64C 2201/12; B64C 39/024

(57) ABSTRACT

A control method for a movable platform, a movable platform, a control terminal, a control device, a control system and a computer-readable storage medium including the control method. The control method may include obtaining a planned path of the movable platform; controlling the movable platform to move according to the planned path; obtaining a remaining amount of a consumable of the movable platform; determining a required replenishment position of the movable platform on the planned path where the remaining amount of the consumable decreases to a remaining amount threshold based on the remaining amount of the consumable; and acquiring a target replenishment position for replenishing the consumable to the movable platform based on the required replenishment position.

### CROSS REFERENCE TO RELATED APPLICATION

The present application is a continuation of International Application No. PCT/CN2019/090062, filed Jun. 05, 2019, the entire contents of which being incorporated herein by reference in its entirety.

### TECHNICAL FIELD

The present disclosure relates to the field of movable platforms, in particular, to a control method of a movable platform, a movable platform, a control terminal, a control device, a control system, and a computer readable storage medium

### BACKGROUND

Movable platforms, such as unmanned aerial vehicles, robots, mobile trolleys, mobile ships, underwater mobile vehicles or the like, play a very important role in many fields such as agriculture, industry, film and television, search and rescue, police, military, etc., which can adapt to complex environments. In the operation of a movable platform, consumables of the movable platform such as a spray of an agricultural unmanned aerial vehicle, a battery power or a fuel will be consumed. Therefore, timely replenishment of the consumables is required to ensure the normal operation of the movable platform.

### SUMMARY

The present disclosure is directed to an improved control method for a movable platform, a movable platform, a control terminal, a control device, a control system, and a computer readable storage medium.

According to one aspect of an embodiment of the present disclosure, a control method of a movable platform is provided for a movable platform, comprising: acquiring a planned path of the movable platform, the planned path being a route guiding the movement of the movable platform; controlling the movable platform to move according to the planned path; obtaining a remaining amount of a consumable of the movable platform, determining a position of the movable platform on the planned path where the remaining amount of the consumable decreases to a remaining amount threshold based on the remaining amount of the consumable, and setting the determined position as a required replenishment position; and acquiring a target replenishment position for replenishing the consumable to the movable platform based on the required replenishment position.

According to another aspect of an embodiment of the present disclosure, a control method of a movable platform is provided for a control terminal, comprising: acquiring a planned path for a movable platform, the planning path being a route guiding the movement of the movable platform; sending the planned path to the movable platform so that the movable platform moves according to the planned path; acquiring a required replenishment position and a target replenishment position. The required replenishment position represents a position of the movable platform on the planned path where a remaining amount of a consumable of the movable platform decreases to a remaining amount threshold, and the target replenishment position represents a position where the consumable is replenished to the movable platform.

According to another aspect of an embodiment of the present disclosure, a control method of a movable platform is provided for a control terminal, comprising: acquiring a planned path for a movable platform, the planned path being a route guiding the movement of the movable platform; controlling the movable platform to move according to the planned path; obtaining a remaining amount of a consumable of the movable platform, determining a position of the movable platform on the planned path where the remaining amount of the consumable decreases to a remaining amount threshold based on the remaining amount of the consumable, setting the determined position as a required replenishment position; and acquiring a target replenishment position where the consumable is replenished to the movable platform based on the required replenishment position.

According to another aspect of an embodiment of the present disclosure, a control method of a movable platform is provided for a movable platform, comprising: acquiring a planned path of the movable platform sent by a control terminal, the planning path being a route guiding the movement of the movable platform; controlling the movable platform to move according to the planned path; acquiring a required replenishment position and a target replenishment position sent by the control terminal, wherein the required replenishment position is a position of the movable platform on the planned path where a remaining amount of a consumption of the movable platform decreases to a remaining amount threshold, and the target replenishment position represents a position where the consumable is replenished to the movable platform; and acquiring a replenishment instruction sent by the control terminal, and controlling the movable platform to move from the required replenishment position to the target replenishment position according to the replenishment instruction. The replenishment instruction is configured to control the movable platform to move from the required replenishment position to the target replenishment position.

According to another aspect of an embodiment of the present disclosure, a control method for a movable platform is provided, comprising: controlling a control terminal to acquire a planned path for a movable platform, the planning path being a route guiding the movement of the movable platform; and controlling the control terminal to send the planned path to the movable platform so that the movable platform may move according to the planned path; controlling the movable platform to acquire the planned path of the movable platform; controlling the movable platform to move according to the planned path; and controlling the movable platform to acquire a remaining amount of a consumable of the movable platform, and determining a position of the movable platform on the planned path where the remaining amount of the consumable decreases to a remaining amount threshold based on the remaining amount of the consumable, and setting the determined position as a required replenishment position; and controlling the movable platform to obtain a target replenishment position for replenishing the consumable to the movable platform based on the required replenishment position, and sending the required replenishment position and the target replenishment position; and controlling the control terminal to obtain the required replenishment position and the target replenishment position

According to another aspect of an embodiment of the present disclosure, a control method for a movable platform is provided, comprising: controlling a control terminal to obtain a planned path for a movable platform, the planned path being a route guiding the movement of the movable platform; controlling the control terminal to send the planned path to the movable platform; controlling the movable platform to acquire the planned path of the movable platform, and controlling the movable platform to move according to the planned path; controlling the control terminal to acquire a remaining amount of a consumable of the movable platform, and determining a position of the movable platform on the planned path where the remaining amount of the consumable decreases to a remaining amount threshold based on the remaining amount of the consumable, and setting the determined position as a required replenishment position; determining a target replenishment position where the consumable is replenished to the movable platform based on the required replenishment position; controlling the control terminal to send the required replenishment position and the target replenishment position to the movable platform, and a replenishment instruction, wherein the replenishment instruction is configured to control the movable platform to move from the required replenishment position to the target replenishment position; and controlling the movable platform to acquire the required replenishment position and the target replenishment position sent by the control terminal, and to obtain control of the replenishment instruction, and controlling the movable platform to move from the required replenishment position to the target replenishment position according to the replenishment instruction.

According to another aspect of an embodiment of the present disclosure, a movable platform is provided, comprising: a body; a power unit arranged in the body to provide power for the movable platform; and one or more processors for implementing any of the control methods disclosed in the present disclosure.

According to another aspect of an embodiment of the present disclosure, a control terminal is provided, including one or more processors for implementing any of the control methods disclosed in the present disclosure.

According to another aspect of an embodiment of the present disclosure, a control device is provided, including one or more processors for implementing any of the control methods disclosed in the present disclosure.

According to another aspect of an embodiment of the present disclosure, a control system is provided, including: a movable platform and a control terminal communicating with the movable platform.

According to another aspect of an embodiments of the present disclosure, a computer-readable storage medium is provided with a program stored thereon that, executed by a processor, implements any of the control methods disclosed in the present disclosure.

The present disclosure may determine a required replenishment position on a planned path of a movable platform and obtain a target replenishment position for the movable platform to replenish consumables to the movable platform based on the required replenishment position. In this way, a better or preferred replenishment position may be determined in a timely manner. Replenishing the movable platform with the consumables in time improves operation efficiency.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without creative work.

FIG. 1 illustrates a flowchart of a control method for a movable platform according to some embodiments of the present disclosure;

FIG. 2 illustrates a flowchart of a control method for a movable platform according to some embodiments of the present disclosure;

FIG. 3 illustrates a flowchart of a control method for a movable platform according to some embodiments of the present disclosure;

FIG. 4 illustrates a flowchart of a control method for a movable platform according to some embodiments of the present disclosure;

FIG. 5 illustrates a flowchart of a control method for a movable platform according to some embodiments of the present disclosure;

FIG. 6 illustrates a flowchart of a control method for a movable platform according to some embodiments of the present disclosure;

FIG. 7 illustrates a perspective view of a movable platform according to some embodiments of the present disclosure;

FIG. 8 illustrates a block diagram of the movable platform shown in FIG. 7 according to some embodiments of the present disclosure;

FIG. 9 illustrates a block diagram of a control terminal according to some embodiments of the present disclosure;

FIG. 10 illustrates a block diagram of a control device according to some embodiments of the present disclosure;

FIG. 11 illustrates a block diagram of a control system according to some embodiments of the present disclosure.

### DETAILED DESCRIPTION

The technical solutions and technical features encompassed in the exemplary embodiments of the present disclosure will be described in detail in conjunction with the accompanying drawings in the exemplary embodiments of the present disclosure. Apparently, the described exemplary embodiments are part of embodiments of the present disclosure, not all of the embodiments. Based on the embodiments and examples disclosed in the present disclosure, all other embodiments obtained by those of ordinary skill in the art without creative work shall fall within the protection scope of the present disclosure.

Here, exemplary embodiments will be described in detail, and examples thereof are shown in the accompanying drawings. When the following description refers to the drawings, unless otherwise indicated, the same numbers in different drawings indicate the same or similar elements. The implementation manners described in the following exemplary embodiments do not represent all implementation manners consistent with the present disclosure. On the contrary, they are only examples of devices and methods consistent with some aspects of the disclosure as detailed in the appended claims. Further, the chart(s) and diagram(s) shown in the drawings are only examples, and does not necessarily include all components, elements, contents and/or operations/steps, nor do they have to be arranged in the described or specific order. For example, some components/elements can also be disassembled, combined or partially combined; therefore, the actual arrangement may be changed or modified according to actual conditions. In the case of no conflict, the components, elements, operations/steps and other features disclosed in the embodiments may be combined with one another.

The terms used herein are only for the purpose of describing specific embodiments and are not intended to limit the disclosure. As used in this disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items. Terms such as “connected” or “linked” are not limited to physical or mechanical connections, and may include electrical connections, whether direct or indirect. Phrases such as “a plurality of,” “multiple,” or “several ” mean two and more.

In accordance with some embodiments of the present disclosure, a control method of a movable platform is provided for a movable platform. The control method may include acquiring a planned path of a movable platform. The planned path is a route that directs or guides the movement of the movable platform. The control method may further include: controlling the movable platform to move according to the planned path; obtaining a remaining amount of a consumable of the movable platform, determining a position of the movable platform on the planned path where the remaining amount of the consumable decreases to a remaining amount threshold based on the remaining amount of the consumable, and setting the determined position as a required replenishment position; and acquiring a target replenishment position where the consumable is replenished to the movable platform based on the required replenishment position.

The control method disclosed may determine the required replenishment position on the planned path of the movable platform and acquire the target replenishment position for the movable platform to replenish the movable platform the consumable based on the required replenishment position. As such, a better or preferred replenishment position may be determined, and the consumable may be replenished to the movable platform timely, thereby improving operation efficiency.

In accordance with some embodiments of the present disclosure, a control method of a movable platform is provided for a control terminal. The control method may include: acquiring a planned path for a movable platform, wherein the planned path is a route guiding the movement of the movable platform; sending the planned path to the movable platform so that the movable platform moves according to the planned path; acquiring a required replenishment position and a target replenishment position, wherein the required replenishment position represents a position of the movable platform on the planned path when a remaining amount of a consumable of the movable platform decreases to a remaining amount threshold, and the target replenishment position represents a position where the consumable is replenished to the movable platform.

In accordance with some embodiments of the present disclosure, a control method of a movable platform is provided for a control terminal. The control method may include: acquiring a planned path of a movable platform, the planned path being a route guiding the movement of the movable platform; controlling the movable platform to move according to the planned path; obtaining a remaining amount of a consumable of the movable platform, determining a position of the movable platform on the planned path where the remaining amount of the consumable decreases to a remaining amount threshold based on the remaining amount of the consumable, setting the determined position as a required replenishment position; and acquiring a target replenishment position where the consumable is replenished to the movable platform based on the required replenishment position.

In accordance with some embodiments of the present disclosure, a control method of a movable platform is provided for a movable platform. The control method may include: acquiring a planned path of a movable platform sent by a control terminal, the planned path being a route guiding the movement of the movable platform; controlling the movable platform to move according to the planned path; acquiring a required replenishment position and a target replenishment position sent by the control terminal, wherein the required replenishment position is a position of the movable platform on the planned path where a remaining amount of a consumable of the movable platform decreases to a remaining amount threshold, and the target replenishment position represents a position where the consumable is replenished to the movable platform; and acquiring a replenishment instruction sent by the control terminal and controlling the movable platform to move from the required replenishment position to the target replenishment position according to the replenishment instruction. The replenishment instruction is configured to control the movable platform to move from the required replenishment position to the target replenishment position.

In accordance with some embodiments of the present disclosure, a control method for a movable platform is provided. The control method may include: controlling a control terminal to acquire a planned path for a movable platform, the planned path being a route guiding the movement of the movable platform; and controlling the control terminal to send the planned path to the movable platform so that the movable platform may move according to the planned path; controlling the movable platform to acquire the planned path of the movable platform; controlling the movable platform to move according to the planned path; controlling the movable platform to acquire a remaining amount of a consumable of the movable platform, and determining a position of the movable platform on the planned path where the remaining amount of the consumable decreases to a remaining amount threshold based on the remaining amount of the consumable, and setting the determined position as a required replenishment position; controlling the movable platform to obtain a target replenishment position for replenishing the consumable to the movable platform based on the required replenishment position; and controlling the control terminal to obtain the required replenishment position and the target replenishment position

In accordance with some embodiments of the present disclosure, a control method for a movable platform is provided. The control method may include: controlling a control terminal to obtain a planned path for a movable platform, the planned path being a route guiding the movement of the movable platform; controlling the control terminal to send the planned path to the movable platform; controlling the movable platform to acquire the planned path of the movable platform, and controlling the movable platform to move according to the planned path; controlling the control terminal to acquire a remaining amount of a consumable of the movable platform, and determining a position of the movable platform on the planned path where the remaining amount of the consumable decreases to a remaining amount threshold based on the remaining amount of the consumable, and setting the determined position as a required replenishment position; determining a target replenishment position where the consumable is replenished to the movable platform based on the required replenishment position; controlling the control terminal to send the required replenishment position and the target replenishment position to the movable platform, and a replenishment instruction, wherein the replenishment instruction is configured to control the movable platform to move from the required replenishment position to the target replenishment position; and controlling the movable platform to acquire the required replenishment position and the target replenishment position sent by the control terminal and to obtain control of the replenishment instruction, and controlling the movable platform to move from the required replenishment position to the target replenishment position according to the replenishment instruction.

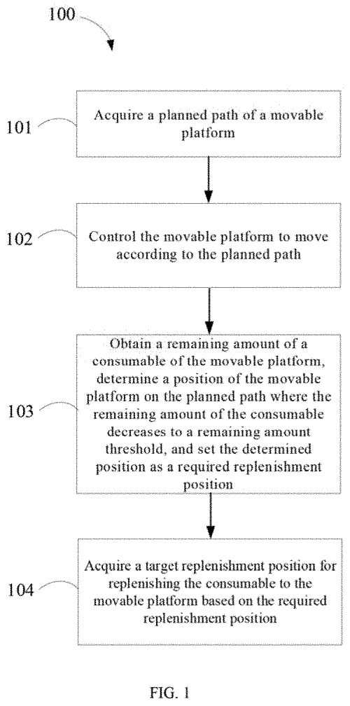

FIG. 1 illustrates a flowchart of a control method 100 for a movable platform according to some embodiments of the present disclosure. The control method 100 is used for a movable platform. The movable platform may include, but is not limited to, an unmanned aerial vehicle, a robot, a mobile trolley, a mobile vehicle, a mobile boat, an underwater mobile equipment, or the like. In some embodiments, the movable platform may be an unmanned aerial vehicle. In one embodiment, the unmanned aerial vehicle may be a plant protection unmanned aerial vehicle. In some embodiments, the control method 100 may include steps 101-104.

In step 101, a planned path of a movable platform is acquired, and the planned path is a route for guiding the movement of the movable platform.

In some embodiments, a planned path of the movable platform sent by a control terminal may be acquired. The control terminal may communicate with the movable platform. The control terminal may generate a planned path and send the planned path to the movable platform. In other embodiments, the movable platform may generate a planned path.

In step 102, the movable platform is controlled to move according to the planned path so that the movable platform is controlled to perform operations according to the planned path. The movable platform may automatically move according to the planned path, so that in the process of operating the movable platform, there is no need for excessive manual intervention, which improves the convenience and efficiency of operations.

In step 103, a remaining amount of a consumable of the movable platform is obtained, and a position of the movable platform on the planned path is determined where the remaining amount of the consumable decreases to a remaining amount threshold based on the remaining amount of the consumable, and the determined position is set as a required replenishment position.

In some embodiments, the consumable may include a spray, a battery power, and/or a fuel, which is gradually reduced during the operation of the movable platform. The spray may be used in a plant protection unmanned aerial vehicle or the like, and may include a medicine solution, a nutrient solution, seeds, a powder and/or water, or the like. The battery power and/or the fuel may provide power energy to the movable platform, provide energy to the power unit of the movable platform, and enable the movable platform to move. The movable platform may be an electric movable platform, an oil-powered movable platform, or a hybrid movable platform. In some other embodiments, the battery power may provide energy to a device other than the power unit of the movable platform.

In some embodiments, the remaining amount threshold may be 0. For example, the remaining amount threshold corresponding to a spray may be 0. In other embodiments, the remaining amount threshold may be greater than 0. For example, the remaining amount threshold may be 1%, 5%, or 10% of the maximum amount of a consumable of the movable platform. For example, the remaining amount thresholds of the spray, the battery power, and/or the fuel may be each greater than 0, respectively. When the remaining amount of the consumable decreases to the remaining amount threshold, indicating that the remaining amount of the consumable is small, and it is necessary to replenish the consumable as soon as possible.

In some embodiments, the required replenishment position is determined based on a current remaining amount of a consumable and a remaining amount threshold. When the current remaining amount of the consumable is less than the remaining amount threshold, a current position of the movable platform on the planned path is directly taken as the required replenishment position, so that the required replenishment position can be simply and quickly determined. In some embodiments, the required replenishment position is determined at least based on the current remaining amount of the consumable, the remaining amount threshold, and a unit consumption rate. The unit consumption rate is used to indicate a reduction amount of the consumable per unit area or unit mileage. The difference between the current remaining amount and the remaining amount threshold may be determined as a remaining consumable quantity, which is the amount of the consumable that can be consumed by the movable platform when the movable platform continues to operate. The required replenishment position on the planned path may be determined by further taking account of the unit consumption rate. As such, it may simply and accurately determine the required replenishment position for replenishment when the remaining amount of the consumable decreases to the remaining amount threshold.

In some embodiments, the unit consumption rate may be determined according to a user's setting. For example, a user can set the consumption rate per unit area of a spray. In other embodiments, the unit consumption may be determined according to the characteristics of the movable platform itself and/or operating environment. For example, according to the movable platform itself and/or the operating environment, the battery power and/or fuel consumption per unit mileage of the movable platform may be determined as the unit consumption rate. The operating environment may include, for example, a wind direction and/or a wind speed during the flight of an unmanned aerial vehicle, or ground conditions during the operation of ground robots and mobile trolleys.

In some embodiments, the unit consumption rate may be preset and kept constant. For example, the consumption rate per unit area of a spray may be set constant, and the unit consumption of battery power and/or fuel may be set as a constant empirical value according to the movable platform itself. In other embodiments, the unit consumption rate may be changed during the operation of the movable platform. For example, during the operation of the movable platform, different crops can be sprayed continuously, and the consumption rate per unit area of a spray may be tailored to different crops and set different values. For another example, the unit consumption rate of battery power and/or fuel may be changed according to changes in the operating environment. During the operation of the movable platform, the required replenishment position may be adjusted according to the changed unit consumption rate, and the required replenishment position may be continuously updated.

In some embodiments, based at least on a current remaining amount of the consumable, the remaining amount threshold, and the unit consumption rate, a distance that the movable platform may move until the remaining amount of the consumable decreases to the remaining amount threshold may be determined. A position reached by the movable platform moving the distance from the current position on the planned path is further determined, and it is the required replenishment position. In this way, the required replenishment position can be easily and accurately determined. By determining the difference between the current remaining amount and the remaining amount threshold, combined with the unit consumption rate, the distance that the movable platform can still move may be determined.

In some embodiments, the consumable may include a spray. According to a current remaining amount of the spray, a remaining amount threshold, a consumption amount per unit area, and a spray width, the required replenishment position may be determined. The difference between the current remaining amount of the spray and the remaining amount threshold may be determined, which is a remaining consumable quantity. The remaining consumable quantity is divided by the consumption rate per unit area to get a remaining sprayable area. Further based on the spray width, a distance that the movable platform may move when the current remaining amount of the consumable decreases to the remaining amount threshold may be determined. Thus, the required replenishment position may be further determined.

For example, in one embodiment, a current remaining amount of the spray is 1 r, the remaining amount threshold is 0, and a user-set consumption rate per mu (that is, the consumption amount per unit area, unit consumption) is m. Then, an area that the current remaining amount may still be operated on s1 (mu)=1 r/m., where mu is a unit of area and equals to 666.67 square meters. From the conversion formula of mu and square meters, it may be determined that the area that the current remaining amount of the spray may operate on s2 (square meters)=666.67*s1. If the spray width is h meters, and the current remaining amount of the spray can last a distance d=s2/h. Thus, the required replenishment position on the planned path can be obtained based on the current position of the movable platform and the planned path. The planned path may be stored on the removable platform.

In some embodiments, the consumable may include at least one of a battery power and a fuel for providing power to the movable platform. According to a current remaining amount of the consumable, a remaining amount threshold and a unit mileage consumption rate, the required replenishment position may be determined. The unit consumption rate of battery power and/or fuel is the unit mileage consumption amount, which represents the reduction of battery power and/or fuel per unit mileage. The difference between the current remaining amount and the remaining amount threshold may be determined, which is a remaining consumable quantity. The remaining consumable quantity is divided by the unit mileage consumption rate to get a movable mileage, that is, a distance that the movable platform may still travel, so that the required replenishment position may be determined on the planned path. In this way, the required replenishment position may be determined simply and more accurately, the processing workload of the movable platform is small, the processing speed is fast, and the required replenishment position may be determined promptly.

In some embodiments, during the movement of the movable platform, the remaining amount of the consumable is acquired in real time, and the required replenishment position is determined in real time based on the remaining amount of the consumable obtained in real time. As such, the required replenishment position may be updated in real time so as to ensure the timely replenishment of the consumable and normal operations. In one embodiment, the consumable includes a spray, and a spray control system of the movable platform may utilize a sensor, such as a level gauge, to obtain a current remaining amount of the spray, and send the current remaining amount to a main control system of the movable platform. Thus, the movable platform may acquire the remaining amount of the consumable in real time through the spray control system.

In step 104, based on the required replenishment position, a target replenishment position for replenishing the consumable to the movable platform is acquired.

In some embodiments, the movable platform determines the target replenishment position based on the required replenishment position, thereby obtaining the target replenishment position. A better or preferred target replenishment position may be determined based on the required replenishment position, and replenishment may be provided to the movable platform at the target replenishment position. In this way, a better or preferred replenishment position may be determined, so that the movable platform may be replenished with the consumable in time, and the operation efficiency is improved.

In some embodiments, the target replenishment position may be selected from a plurality of replenishment positions based on distances from each of the replenishment positions to the required replenishment position. Replenishment may be performed at the nearest target replenishment position to the required replenishment position, so as to replenish the movable platform with the consumable in time. The plurality of replenishment positions may be pre-set, and a better or preferred replenishment position may be selected from the plurality of replenishment positions as the target replenishment position based on the required replenishment position. The replenishment positions may be set outside the operating area of the movable platform.

In some embodiments, from a plurality of replenishment positions, a replenishment position whose distance to the required replenishment position is less than a distance threshold is set as the target replenishment position. As such, timely replenishment can be ensured, and the movable platform may move a shorter distance to the target replenishment position, and save energy. The target replenishment position may also be a position where an amount of the consumable stored reaches a threshold of the consumable. For example, the target replenishment position is a position where the amount of the consumable stored therein is the largest among a plurality of surrounding target replenishment positions. As such, sufficient supplies of the consumable may be ensured, and subsequent operations may be facilitated. In some embodiments, the consumable is a battery power and/or a fuel, and a distance threshold may be determined based on a remaining amount of the consumable which the movable platform can use to reaches the required replenishment position, so as to ensure that the remaining battery power and/or fuel may move the movable platform to the target replenishment position. In some embodiments, from a plurality of replenishment positions, the replenishment position with the shortest distance to the required replenishment position may be determined as the target replenishment position.

In some embodiments, obstacle information is acquired, and the target replenishment position may be determined based on a distance from a replenishment position to the required replenishment position and the obstacle information. Obstacle information may be obtained through a vision system, a radar, etc., and the obstacle information may include the distance and orientation of an obstacle with respect to the movable platform. In one embodiment, a positional relationship between the obstacle and the required replenishment position and a positional relationship between the obstacle and the replenishment positions may be determined based on the obstacle information, and then the target replenishment position may be determined. As such, when the obstacle is taken into account in determining the target replenishment position, the movable platform may have a better moving path from the required replenishment position to the target replenishment position, thereby facilitating the movement of the movable platform.

In some embodiments, replenishment movement distances from the required replenishment position to each of the replenishment position while avoiding obstacles is acquired, and the replenishment position whose replenishment movement distance is less than a distance threshold is determined as the target replenishment position. As such, the movable platform may be replenished at the target replenishment position proximate the required replenishment position while avoiding obstacles, so as to replenish the movable platform in time and save energy. In one embodiment, the shortest replenishment movement distance among the replenishment movement distances corresponding to the plurality of replenishment positions may be determined, and the replenishment position corresponding to the shortest replenishment movement distance is used as the target replenishment position.

In other embodiments, an area where a distance to the required replenishment position is less than a distance threshold is determined to be a replenishment area. In the replenishment area, the target replenishment position is determined, so that the replenishment can be carried out in time, saving energy. Moreover, the target replenishment position may be determined more flexibly according to the actual operating environment, and a user can go to the target replenishment position to replenish the movable platform. In the replenishment area, an area outside the operating area of the movable platform may be determined, and the target replenishment position may be determined in that area. The target replenishment position may also be determined to facilitate the movable platform moving from the required replenishment position to the target replenishment position, to facilitate stable parking of the movable platform, and to facilitate the user to replenish the movable platform at this position.

In other embodiments, the target replenishment position determined by a control terminal is obtained based on the required replenishment position. The movable platform sends the required replenishment position to the control terminal, and the control terminal may determine the target replenishment position based on the required replenishment position according to the methods disclosed above. This may mitigate the processing work of the movable platform.

In some embodiments, there are a plurality of consumables. When various consumables are reduced to their corresponding remaining amount thresholds, the corresponding required replenishment positions of the movable platform on the planned path are determined, respectively. A target replenishment position based on at least one of the required replenishment positions corresponding to the plurality of consumables is determined. In this way, the situation of the plurality of consumables may be comprehensively considered, and an optimal or preferred replenishment position may be determined, so that the plurality of consumables can be replenished in time.

In some embodiments, the corresponding target replenishment positions are respectively determined based on the required replenishment positions corresponding to the plurality of consumables. The corresponding consumables may be replenished at the corresponding target replenishment positions, so that the consumables may be replenished in time when they need to be replenished. In other embodiments, among the required replenishment positions corresponding to the plurality of consumables, a nearest required replenishment position that is closest to the current position of the movable platform on the planned path is determined, and the target replenishment position is determined based on the nearest required replenishment position. When the movable platform reaches the nearest required replenishment position, it can move to the target replenishment position, and get a variety of the consumables replenished at the same time, so that the movable platform may continue to operate for a long time, thereby improving operation efficiency.

In some embodiments, the plurality of consumables may include at least two of a spray, a battery power, and a fuel. When it is determined that at least two of the remaining amount of the spray, the remaining amount of the battery power, and the remaining amount of the fuel decrease to the corresponding remaining amount thresholds, the corresponding required replenishment positions of the movable platform on the planned path are determined. In one embodiment, the required replenishment position corresponding to the spray and the required replenishment position corresponding to the battery power or fuel may be determined, and the target replenishment position may be determined based on at least one of the required replenishment positions. In one embodiment, when the spray needs to be replenished, the spray may be replenished at the target replenishment position, and the battery may be replaced, or fuel may be replenished at the same time. In another embodiment, when the spray needs to be replenished, the spray may be replenished at its corresponding target replenishment position. When the battery needs to be replaced, the battery may be replaced at its corresponding target replenishment position. When the fuel needs to be refilled, the fuel may be refilled at its corresponding target replenishment position. In some other embodiments, at the target replenishment position, a user can determine the replenishment of the consumables by himself based on the remaining amount of the consumables.

In some embodiments, the control method 100 may further include: sending information of the target replenishment position to a control terminal; acquiring a feedback signal generated by the control terminal according to the information of the target replenishment position; and if the feedback signal indicates that the movable platform is allowed to move to the target replenishment position, controlling the movable platform to move to the target replenishment position when the movable platform reaches the required replenishment position. The movable platform may be controlled to send the information of the target replenishment position to the control terminal, which may be used to prompt a user whether to grant the movable platform to move to the target replenishment position. The control terminal may be controlled to generate a feedback signal, and the feedback signal may indicate whether the movable platform is allowed to move to the target replenishment position. If the movable platform is allowed to move to the target replenishment position, when the movable platform reaches the required replenishment position, the movable platform may be controlled to move to the target replenishment position and replenish the consumables at the target replenishment position. This allows the user to determine whether to grant the movable platform to move to the target replenishment position, giving the user the right to choose, thereby improving the user's experience.

In one embodiment, if the feedback signal indicates that the movable platform is allowed to move to the target replenishment position, a replenishment planned path from the required replenishment position to the target replenishment position may be obtained, and the movable platform is controlled to move to the target replenishment position according to the replenishment planned path. The movable platform may be controlled to automatically move to the target replenishment position, with a high degree of automation and intelligence. In one embodiment, the movable platform may be controlled to determine a replenishment planned path. In another embodiment, the movable platform may be controlled to obtain a replenishment planned path determined by the control terminal.

In another embodiment, if the feedback signal indicates that the movable platform is allowed to move to the target replenishment position, a movement control signal of the control terminal is acquired, and the movable platform is controlled to move to the target replenishment position according to the movement control signal. The control terminal may be controlled to obtain a movement control operation of a user to generate a movement control signal for manually controlling the movement of the movable platform. The movement control signal may control the movement direction and/or posture of the movable platform, etc., so as to achieve manual control of the movable platform to move to the target replenishment position.

In one embodiment, if the feedback signal indicates that the movement to the target replenishment position is denied, a movement control signal of the control terminal is obtained, and the movable platform is controlled to move to a replenishment position according to the movement control signal. A user may generate the movement control signal for manually manipulating the movement of the movable platform by operating the control terminal and manipulate the movable platform to move to a replenishment position desired by the user, so that the individual needs of the user can be met and the user's experience is improved.

In another embodiment, if the feedback signal indicates that the movement to the target replenishment position is denied, the target replenishment position may be re-determined. According to the required replenishment position, another replenishment position may be determined from the plurality of replenishment positions as a target replenishment position. Thus, the new target replenishment position may be determined to meet the needs of a user and improve user's experience.

In some embodiments, a plurality of target replenishment positions may be determined; information of the plurality of target replenishment positions is sent to a control terminal; and a feedback signal generated by the control terminal according to the information of the plurality of target replenishment positions is acquired. If the feedback signal indicates that one of the plurality of target replenishment positions is selected, the movable platform is controlled to move to the selected target replenishment position when the movable platform reaches the required replenishment position. A plurality of target replenishment positions may be determined for a user to choose, and the user may select one of the plurality of target replenishment positions as needed, thereby improving the user's experience. A plurality of target replenishment positions may be determined based on the required replenishment position. A plurality of replenishment positions each having a distance from the required replenishment position less than a distance threshold may be determined to be the target replenishment positions.

In some embodiments, when the movable platform reaches the required replenishment position, the movable platform is controlled to move to the target replenishment position. When the movable platform reaches the required replenishment position, it may automatically move to the target replenishment position with a high degree of automation. In some embodiments, after the consumables are replenished to the movable platform, the movable platform is controlled to continue operation. The movable platform may return to the required replenishment position and continue the operation to complete the task.

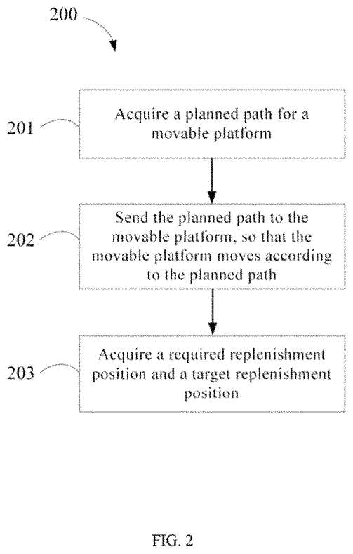

FIG. 2 illustrates a flowchart of a control method 200 of a movable platform according to some embodiments of the present disclosure. The control method 200 is used for a control terminal, which may communicate with a movable platform. The control method 200 may include steps 201-203.

In step 201, a planned path for a movable platform is acquired, and the planned path is a route that guides the movement of the movable platform.

In some embodiments, the control terminal may be controlled to determine a planned path. In one embodiment, a planned path generation operation of a user on a display interface of the control terminal is obtained to generate the planned path of the movable platform. The control terminal may be controlled to generate the planned path according to the user's planned path generation operation, so that the individual needs of the user can be met.

In one embodiment, a selection operation of a user on a pre-set planned path is obtained to generate a planned path of the movable platform. The planned path may be pre-stored in the control terminal, and the user may select the pre-set planned path as the planned path for the movement of the movable platform for an operation. This allows for a faster acquisition of the planned path.

In another embodiment, a planning operation for path planning performed by a user through the control terminal is obtained to generate a planned path for the movable platform. The user may plan a path that meets the needs of an operation according to the needs of the operation, as the planned path of the movable platform. In one embodiment, the control terminal acquires information of dotting in the actual operating area by the user through the control terminal and generates the planned path according to the information. In another embodiment, information about the movement dotting of the movable platform is acquired, and a planned path is generated based on the information. A path may be generated through dotting of the movement of the movable platform, and the user may adjust the path on the display interface to generate a planned path of the movable platform. In yet another embodiment, the control terminal obtains a dotting operation of a user on the display interface of the control terminal, and generates a planned path according to the dotting operation. The display interface displays an operating area. The user dots in the operating area, and the control terminal generates a planned path.

In step 202, the planned path is sent to the movable platform, so that the movable platform moves according to the planned path.

In some embodiments, the movable platform automatically moves according to the planned path. In other embodiments, after acquiring the planned path, a planned path instruction is generated, and the planned path instruction is used to control the movable platform to move according to the planned path. The planned path instruction may be sent to the movable platform so that the movable platform may move according to the planned path. The movable platform can be controlled to move according to the planned path instruction. As such, the control terminal controls the movement of the movable platform.

In step 203, a required replenishment position and a target replenishment position are acquired. The required replenishment position represents a position of the movable platform on the planned path where remaining amount of a consumable of the movable platform decreases to a remaining amount threshold. The target replenishment position represents a position where the consumable is replenished to the movable platform.

In one embodiment, the required replenishment position and the target replenishment position determined by the movable platform may be obtained. In another embodiment, the required replenishment position determined by the movable platform may be acquired, and the control terminal determines the target replenishment position based on the required replenishment position. The method for determining the required replenishment position and the target replenishment position may refer to the methods described above, which will not be repeated herein.

In some embodiments, after the required replenishment position and the target replenishment position are acquired, display information for displaying the required replenishment position and the target replenishment position is generated, and the display information is displayed. The control terminal may display the display information of the required replenishment position and the target replenishment position and prompt a user so that the user may know the required replenishment position and the target replenishment position. In some embodiments, after obtaining the required replenishment position and the target replenishment position, a movement control operation of the user on a manual operation component of the control terminal is acquired to generate a movement control signal, and the movement control signal is sent to the movable platform to control the movable platform to move to the target replenishment position. The user may manually control the movable platform as desired.

In some embodiments, after obtaining the required replenishment position and the target replenishment position, confirmation request information for prompting a user to confirm the target replenishment position is generated; a confirmation operation of a user feedback on the confirmation request information is obtained, and a feedback signal is generated according to the confirmation operation. The feedback signal is used to determine whether to automatically control the movable platform to move to the target replenishment position; and according to the feedback signal, whether to automatically control the movable platform to move to the target replenishment position is determined. As such, the user is provided with the right to select, and the user may select whether the movable platform automatically moves to the target replenishment position.

In some embodiments, if the feedback signal indicates that the movable platform is allowed to automatically move to the target replenishment position, a control movement instruction is generated. The control movement instruction is used to control the movable platform to automatically move to the target replenishment position. The control movement instruction is sent to the movable platform to control the movable platform to automatically move to the target replenishment position when it reaches the required replenishment position. In this way, the movable platform may automatically move to the target replenishment position with a high degree of automation. In some embodiments, a replenishment planned path from the required replenishment position to the target replenishment position is acquired, and a replenishment planned path instruction is generated and sent to the movable platform to control the movable platform to move to the target replenishment position according to the replenishment planned path. As such, the movable platform may automatically move to the target replenishment position according to the planned replenishment path with a high degree of automation.

In some embodiments, if the feedback signal indicates that the movable platform is denied moving automatically to the target replenishment position, a movement control operation of a user on a manual operation component of the control terminal is acquired to generate a movement control signal, and the movement control signal is sent to the movable platform to control the movable platform to move to the target replenishment position. As such, the movable platform is manually controlled to move to the target replenishment position. In other embodiments, if the feedback signal indicates that the movable platform is denied moving automatically to the target replenishment position, the target replenishment position may be re-determined.

In some embodiments, a plurality of target replenishment positions is acquired; display information for displaying the required replenishment position and the plurality of the target replenishment positions is generated, the display information is displayed, and selection request information for prompting a user to select a target replenishment position is generated; a selection operation of the user to select the target replenishment position is obtained to generate a feedback signal. If the feedback signal indicates that one of the plurality of the target replenishment positions is selected, the movable platform is controlled to move to the selected target replenishment position when it reaches the required replenishment position. The plurality of target replenishment positions may be displayed, and the user may select one of the plurality of the target replenishment positions.

The control method 200 may determine a better or preferred replenishment position to replenish consumables to the movable platform in time, thereby improving operation efficiency. For additional description of steps of the control method 200, reference may be made to the detailed description of the control method 100 described above, which will not be repeated herein.

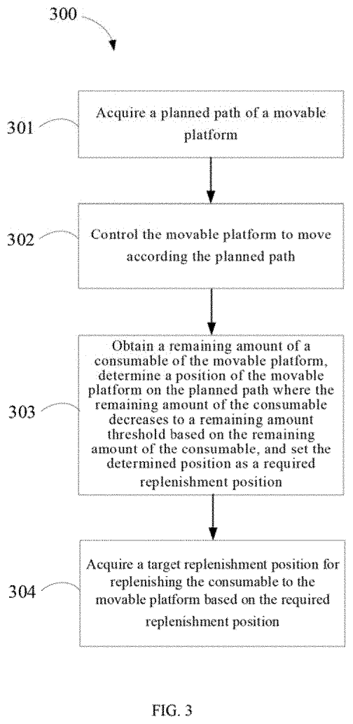

FIG. 3 illustrates a flowchart of a control method 300 of a movable platform according to some embodiments of the present disclosure. The control method 300 is used for a control terminal. The control method 300 may include steps 301-304.

In step 301, a planned path of a movable platform is acquired, and the planned path is a route guiding the movement of the movable platform.

In step 302, according to the planned path, the movable platform is controlled to move according to the planned path.

In step 303, a remaining amount of a consumable of the movable platform is obtained, and according to the remaining amount of the consumable, a position of the movable platform on the planned path is determined when the remaining amount of the consumable decreases to a remaining amount threshold, and the determined position is set as a required replenishment position.

In step 304, according to the required replenishment position, a target replenishment position for replenishing the consumable to the movable platform is acquired. As such, a better or preferred replenishment position may be determined, and the movable platform may be replenished with the consumable timely, thereby improving the operation efficiency.

In some embodiments, the required replenishment position is determined according to a current remaining amount of the consumable and the remaining amount threshold. When the current remaining amount of the consumable is less than the remaining amount threshold at a position on the planned path, this position is directly used as the required replenishment position. In some embodiments, the required replenishment position may be determined based at least on the current remaining amount of the consumable, the remaining amount threshold, and a unit consumption rate, and the unit consumption rate is used to indicate the reduction amount of the consumable per unit area or per unit mileage.

In some embodiments, based at least on the current remaining amount of the consumable, the remaining amount threshold, and the unit consumption rate. a distance that the movable platform may move when the remaining amount of the consumable decreases to the remaining amount threshold is determined. A position reached by the movable platform moving the determined distance from the current position on the planned path is further determined, which is set as the required replenishment position.

In some embodiments, the consumable may include a spray; the required replenishment position may be determined based on a current remaining amount of the spray, a remaining amount threshold, a consumption rate per unit area, and a spray width.

In some embodiments, the consumable may include at least one of a battery power and a fuel used to provide power to the movable platform. The required replenishment position is determined based on a current remaining amount of the consumable, a remaining amount threshold, and a unit mileage consumption rate.

In some embodiments, during the movement of the movable platform, a remaining amount of the consumable is acquired in real time; and based on the remaining amount of the consumable acquired in real time, the required replenishment position is determined in real time.

In some embodiments, there are a plurality of consumables. Corresponding required replenishment positions of the plurality of consumables of the movable platform on the planned path are respectively determined when the plurality of the consumables is reduced to their corresponding remaining thresholds; and according to at least one of the required replenishment positions corresponding to the plurality of consumables, the target replenishment position is determined.

In some embodiments, corresponding target replenishment positions are respectively determined based on the required replenishment positions corresponding to the plurality of consumables.

In some embodiments, a nearest required replenishment position that is closest to the current position of the movable platform on the planned path among the required replenishment positions corresponding to the plurality of consumables is obtained; and the target replenishment position is determined based on the nearest required replenishment position.

In some embodiments, the plurality of consumables may include at least two of a spray, a battery power, and a fuel. When at least two of the remaining amount of the spray, the remaining amount of the battery power, and the remaining amount of the fuel decrease to their corresponding remaining amount thresholds, the corresponding required replenishment positions of the movable platform on the planned path are determined.

In some embodiments, display information for displaying the required replenishment position and the target replenishment position is generated; the display information is displayed, and confirmation request information for prompting a user to confirm the target replenishment position is generated; a confirmation operation of a user feedback on the confirmation request information is obtained, and a feedback signal is generated. If the feedback signal indicates that the movable platform is allowed to automatically move to the target replenishment position, a control movement instruction is generated, the control movement instruction being used to control the movable platform to automatically move to the target replenishment position, and the control movement instruction is sent to the movable platform so that the movable platform is controlled to move to the target replenishment position when the movable platform reaches the required replenishment position.

In some embodiments, if the feedback signal indicates that the movable platform is denied moving automatically to the target replenishment position, a movement control operation of a user on a manual operation component of the control terminal is acquired to generate a movement control signal. The movement control signal is sent to the movable platform so that the movable platform is controlled to move to the target replenishment position.

In some embodiments, if the feedback signal indicates that the movable platform is denied moving to the target replenishment position, the target replenishment position may be re-determined.

In some embodiments, if the feedback signal indicates that the movable platform is allowed to automatically move to the target replenishment position, a replenishment planned path from the required replenishment position to the target replenishment position is obtained, a replenishment planned path instruction is generated, and sent to the movable platform so that the movable platform is controlled to move to the target replenishment position according to the replenishment planned path.

In some embodiments, if the feedback signal indicates that the movable platform is allowed to move automatically to the target replenishment position, a movement control operation of a user on a manual operation component of the control terminal is acquired to generate a movement control signal. The movement control signal is sent to the movable platform so that the movable platform is controlled to move to the target replenishment position.

In some embodiments, after the movable platform is controlled to move to the target replenishment position, and replenished with the consumable, the movable platform is controlled to continue operations.

In some embodiments, a plurality of the target replenishment positions are determined; display information for displaying the required replenishment position and the plurality of the target replenishment positions is generated, the display information is displayed, and selection request information for prompting a user to select a target replenishment position is generated; and a selection operation of the user to select the target replenishment position is obtained to generate a feedback signal. If the feedback signal indicates that one of the plurality of the target replenishment positions is selected, the movable platform is controlled to move to the selected target replenishment position when the movable platform reaches the required replenishment position.

In some embodiments, the target replenishment position is determined from a plurality of replenishment positions according to distances from each of the replenishment positions to the required replenishment position.

In some embodiments, among a plurality of replenishment positions, it is determined that a replenishment position whose distance to the required replenishment position is less than a distance threshold is the target replenishment position.

In some embodiments, obstacle information is obtained; the target replenishment position is determined based on a distance from a replenishment position to the required replenishment position and the obstacle information.

In some embodiments, a replenishment movement distance from the required replenishment position to a replenishment position while avoiding obstacles is obtained; and it is determining that the replenishment position whose replenishment movement distance is less than a distance threshold is the target replenishment position.

In some embodiments, it is determined that an area where a distance to the required replenishment position is less than a distance threshold is a replenishment area; and in the replenishment area, the target replenishment position is determined.

In some embodiments, a planned path generation operation of a user on a display interface of the control terminal is acquired to generate the planned path of the movable platform. In some embodiments, a selection operation of a user on a pre-set planned path is obtained to generate the planned path of the movable platform. Optionally, a planning operation for path planning performed by a user through the control terminal is acquired to generate the planned path of the movable platform.

In some embodiments, after acquiring the planned path, a planned path instruction is generated, the planned path instruction is used to control the movable platform to move according to the planned path; and the planned path instruction is sent to the movable platform so that the movable platform moves according to the planned path.

For more detailed description of the steps of the control method 300, please refer to the relevant descriptions of the control methods 100 and 200 disclosed above, which will not be repeated herein.

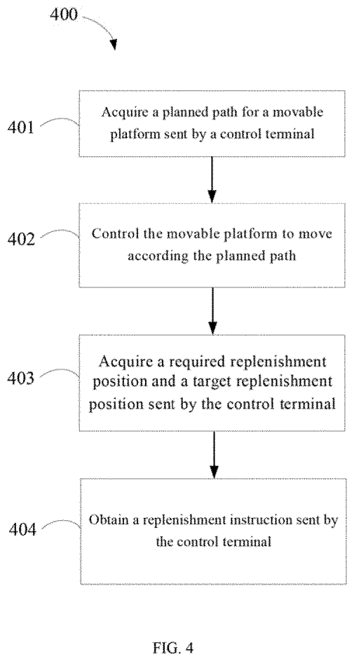

FIG. 4 illustrates a flowchart of a control method 400 of a movable platform according to some embodiments of the present disclosure, which is used for a movable platform. The control method 400 may include steps 401-404.

In step 401, a planned path for a movable platform sent by a control terminal is acquired, and the planned path is a route for guiding the movement of the movable platform. The control terminal may generate the planned path.

In step 402, according to the planned path, the movable platform is controlled to move according to the planned path.

In step 403, a required replenishment position and a target replenishment position sent by the control terminal are acquired, wherein the required replenishment position is a position of the movable platform on the planned path when a remaining amount of a consumable of the movable platform decreases to a remaining amount threshold, and the target replenishment position represents a position where the consumable is replenished to the movable platform. The control terminal may determine the required replenishment position and the target replenishment position.

In step 404, a replenishment instruction sent by the control terminal is obtained, and the movable platform is controlled to move from the required replenishment position to the target replenishment position according to the replenishment instruction. The replenishment instruction is used to control the movable platform to move from the required replenishment position to the target replenishment position. As such, a better or preferred replenishment position may be determined, and the movable platform may be replenished with the consumable in time, which improves the operation efficiency.

For further detailed description of the steps of the control method 400, reference may be made to the relevant descriptions of the control methods 100, 200, and 300 disclosed above, which will not be repeated herein.

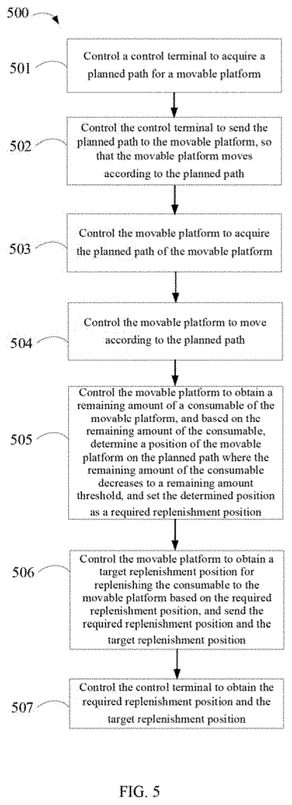

FIG. 5 illustrates a flowchart of a control method 500 for a movable platform according to some embodiments of the present disclosure. The control method 500 may include steps 501-507.

In step 501, a control terminal is controlled to acquire a planned path for a movable platform, and the planned path is a route guiding the movement of the movable platform.

In step 502, the control terminal is controlled to send the planned path to the movable platform, so that the movable platform may move according to the planned path.

In step 503, the movable platform is controlled to acquire the planned path of the movable platform.

In step 504, the movable platform is controlled to move according to the planned path.

In step 505, the movable platform is controlled to obtain a remaining amount of a consumable of the movable platform, and based on the remaining amount of the consumable, a position of the movable platform on the planned path is determined where the remaining amount of the consumable decreases to a remaining amount threshold, the determined position is set as a required replenishment position.

In step 506, the movable platform is controlled to obtain a target replenishment position for replenishing the consumable to the movable platform based on the required replenishment position, and the required replenishment position and the target replenishment position are sent.

In some embodiments, the movable platform may directly send the required replenishment position and the target replenishment position to the control terminal that establishes a communication connection with the movable platform. When the control terminal is the only one that establishes the communication connection with the movable platform, the control terminal directly obtains the corresponding information for quick response. In some embodiments, when the control terminal that establish a communication connection with the movable platform includes a plurality of control terminals, the movable platform sends the required replenishment position and the target replenishment position directly to a designated control terminal which establishes a communication connection with the movable platform, so that the designated control terminal responds quickly, wherein the designated control terminal may be pre-designated by a user. In other embodiments, the movable platform may also broadcast the required replenishment position and the target replenishment position in the form of broadcast, so that a control terminal or a movable platform with an information receiving function may also obtain this broadcasted information.

In step 507, the control terminal is controlled to obtain the required replenishment position and the target replenishment position. As such, a better or preferred replenishment position may be determined, and the movable platform may be replenished with the consumable in time, which improves the operation efficiency.

In some embodiments, the required replenishment position is determined based on a current remaining amount of the consumable and the remaining amount threshold. When the current remaining amount of the consumable is less than the remaining amount threshold, this position is directly set as the required replenishment position. In some embodiments, the required replenishment position is determined based at least on the current remaining amount of the consumable, the remaining amount threshold, and a unit consumption rate, and the unit consumption rate is used to indicate the reduction amount of the consumable per unit area or per unit mileage.

In some embodiments, based at least on the current remaining amount of the consumable, the remaining amount threshold and the unit consumption rate, a distance that the movable platform may move when the current remaining amount of the consumable decreases to the remaining amount threshold is determined. A position reached by the movable platform moving the determined distance from the current position on the planned path is the required replenishment position.

In some embodiments, the consumables may include a spray. The required replenishment position is determined based on a current remaining amount of the spray, a remaining amount threshold, a consumption rate per unit area, and a spray width. In other embodiments, the consumable may include at least one of a battery power and a fuel used to provide power to the movable platform. The required replenishment position is determined based on a current remaining amount of the consumable, a remaining amount threshold, and a unit mileage consumption rate.

In some embodiments, during the movement of the movable platform, the remaining amount of the consumable is acquired in real time; and based on the remaining amount of the consumables acquired in real time, the required replenishment position is determined in real time.

In some embodiments, there are a plurality of consumables. When the remaining amount of each of the plurality of consumables decreases to its corresponding remaining amount threshold, the corresponding required replenishment positions of the movable platform on the planned path are respectively determined; the target replenishment position is determined based on at least one of the required replenishment requirements corresponding to the plurality of consumables.

In some embodiments, the corresponding target replenishment positions are respectively determined based on the required replenishment positions corresponding to the plurality of consumables.

In some embodiments, a nearest required replenishment position that is closest to the current position of the movable platform on the planned path among the required replenishment positions corresponding to the plurality of consumables is determined; the target replenishment position is determined based on the nearest required replenishment position.

In some embodiments, the plurality of consumables may include at least two of a spray, a battery power, and a fuel. When at least two of the remaining amount of the spray, the remaining amount of the battery power, and the remaining amount of the fuel decrease to their corresponding remaining amount thresholds, the corresponding required replenishment positions of the movable platform on the planned path are respectively determined.

In some embodiments, the control method 500 of a movable platform may further include: generating display information for displaying the required replenishment position and the target replenishment position; and displaying the display information.

In some embodiments, after the target replenishment position is determined, confirmation request information for prompting a user to confirm the target replenishment position is generated; a confirmation operation of a user feedback on the confirmation request information is obtained, a feedback signal is generated according to the confirmation operation, the feedback signal is used to determine whether to automatically control the movable platform to move to the target replenishment position; according to the feedback signal, whether to automatically control the movable platform to move to the target replenishment position is determined.

In some embodiments, if the feedback signal indicates that the movable platform is allowed to move automatically to the target replenishment position, the movable platform is controlled to move automatically to the target replenishment position when it reaches the required replenishment position.

In some embodiments, a replenishment planned path from the required replenishment position to the target replenishment position is obtained; the movable platform is controlled to move to the target replenishment position according to the replenishment planned path.

In some embodiments, if the feedback signal indicates that the movable platform is denied moving automatically to the target replenishment position, a movement control operation of a user on a manual operation component of the control terminal is acquired, and the movable platform is controlled to move to the target replenishment position according to the movement control operation.

In some embodiments, a movement control operation of a user on a manual operation component of the control terminal is acquired, and the movable platform is controlled to move to the target replenishment position according to the movement control operation.

In some embodiments, if the feedback signal indicates that the movable platform is denied moving to the target replenishment position, the target replenishment position may be re-determined.

In some embodiments, if the feedback signal indicates that one of the plurality of target replenishment positions is selected, the movable platform is controlled to move to the selected target replenishment position when it reaches the required replenishment position.

In some embodiments, acquiring a planned path of the movable platform may include acquiring a planned path generation operation of a user on a display interface of the control terminal to generate the planned path of the movable platform.

In some embodiments, acquiring a planned path generation operation of a user on a display interface of the control terminal may include obtaining a selection operation of the user on a preset planned path to generate the planned path of the movable platform, or obtaining the planned path generation operation performed by the user through the control terminal for path planning to generate the planned path of the movable platform.

In some embodiments, the control method 500 of the movable platform may include: determining a plurality of the target replenishment positions; generating display information for displaying the required replenishment position and the plurality of the target replenishment positions, and displaying the display information, and generating selection request information for prompting a user to select a target replenishment position; obtaining a selection operation of the user to select the target replenishment position to generate a feedback signal; and if the feedback signal indicates that one of the plurality of the target replenishment positions is selected, controlling the movable platform to move to the selected target replenishment position when the movable platform reaches the required replenishment position.

In some embodiments, the control method 500 of a movable platform further includes: when the movable platform reaches the required replenishment position, controlling the movable platform to move to the target replenishment position; and after the movable platform is replenished with the consumable, controlling the movable platform to continue operations.

In some embodiments, the target replenishment position is determined from a plurality of replenishment positions based on distances from each of the replenishment positions to the required replenishment position.

In some embodiments, among a plurality of replenishment positions, it is determined that a replenishment position whose distance to the required replenishment position is less than a distance threshold is the target replenishment position.

In some embodiments, obstacle information is acquired; the target replenishment position is determined based on distances from a plurality of replenishment positions to the required replenishment position and the obstacle information.

In some embodiments, a replenishment movement distance from the required replenishment position to a replenishment position while avoiding obstacles is obtained; the replenishment position whose replenishment movement distance is less than a distance threshold is determined as the target replenishment position.

In some embodiments, it is determined that an area where a distance to the required replenishment position is less than a distance threshold is a replenishment area; and the target replenishment position is determined in the replenishment area.

In some embodiments, controlling the control terminal to obtain a planned path for the movable platform may include controlling the control terminal to obtain a planned path generation operation of a user on the control terminal, and generating the planned path of the movable platform according to the planned path generation operation.

In some embodiments, a selection operation of a user on a pre-set planned path is acquired to generate the planned path of the movable platform; or a planning operation for path planning performed by a user through the control terminal is acquired to generate the planned path of the movable platform.

In some embodiments, the planned path of the movable platform sent by the control terminal is acquired.

In some embodiments, the movable platform is controlled to determine the target replenishment position based on the required replenishment position. In some embodiments, the required replenishment position and the target replenishment position are sent to the control terminal.

For further additional description of the steps of the control method 500, reference may be made to the related descriptions of the control methods 100, 200, 300, and 400 disclosed above, which will not be repeated herein.

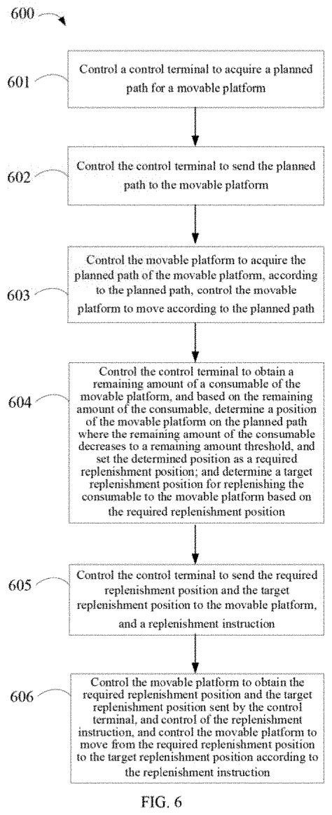

FIG. 6 illustrates a flowchart of a control method 600 of a movable platform according to some embodiments of the present disclosure. The control method 600 may include steps 601-606.

In step 601, a control terminal is controlled to obtain a planned path for a movable platform, and the planned path is a route guiding the movement of the movable platform.

In step 602, the control terminal is controlled to send the planned path to the movable platform.

In step 603, the movable platform is controlled to obtain the planned path of the movable platform, and the movable platform is controlled to move according to the planned path.

In step 604, the control terminal is controlled to obtain a remaining amount of a consumable of the movable platform, and based on the remaining amount of the consumable, a position of the movable platform on the planned path when the remaining amount of the consumable decreases to a remaining amount threshold is determined. The determined position is set as a required replenishment position; and based on the required replenishment position, a target replenishment position for replenishing the consumable to the movable platform is determined.

In step 605, the control terminal is controlled to send the required replenishment position and the target replenishment position to the movable platform, and a replenishment instruction, wherein the replenishment instruction is used to control the movable platform to move from the required replenishment position to the target replenishment position.

In step 606, the movable platform is controlled to obtain the required replenishment position and the target replenishment position sent by the control terminal, and control of the replenishment instruction. The movable platform is controlled to move from the required replenishment position to the target replenishment position according to the replenishment instruction. As such, a better or preferred replenishment position can be determined, and the movable platform can be replenished with the consumable in time, which improves the operation efficiency.

In some embodiments, the control terminal is controlled to obtain a planned path generation operation of a user on a display interface of the control terminal to generate the planned path of the movable platform.

In some embodiments, a selection operation of a user on a pre-set planned path is acquired to generate the planned path of the movable platform; or a planning operation for path planning performed by a user through the control terminal is acquired to generate the planned path of the movable platform.

In some embodiments, after the control terminal is controlled to obtain the planned path of the movable platform, a planned path instruction is generated, wherein the planned path instruction is used to control the movable platform to move according to the planned path. The planned path instruction is sent to the movable platform, so that the movable platform moves according to the planned path.

For further additional description of the steps of the control method 600, reference may be made to the relevant descriptions of the control methods 100, 200, 300, 400, and 500 disclosed above, which will not be repeated herein.

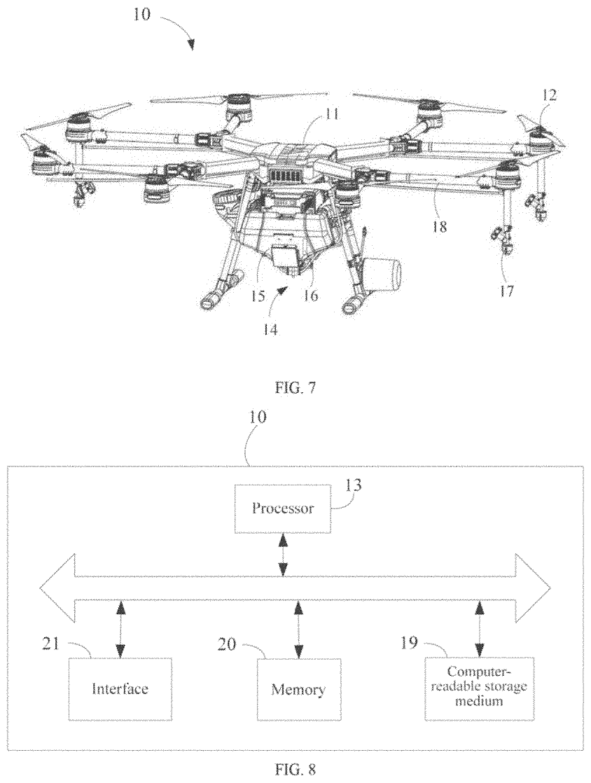

FIG. 7 illustrates a perspective view of a movable platform 10 according to some embodiments of the present disclosure. In one embodiment, the movable platform 10 may include an unmanned aerial vehicle. In the illustrated embodiment, the unmanned aerial vehicle may include a plant protection unmanned aerial vehicle. In some other embodiments, the movable platform 10 may include, but is not limited to, a robot, a mobile trolley, a mobile boat, or an underwater mobile equipment.

FIG. 8 illustrates a block diagram of the movable platform 10 shown in FIG. 7 according to some embodiments of the present disclosure. Referring to FIGS. 7 and 8, the movable platform 10 may include a body 11, a power unit 12 and one or more processors 13. The power unit 12 is provided in the body 11 and is configured to provide power to the movable platform 10. In one embodiment, the power unit 12 may include rotors. In some other embodiments, the power unit 12 may include fixed wings or wheels or the like. In one embodiment, the one or more processors 13 are configured to implement the control method 100. In another embodiment, the one or more processors 13 are configured to implement the control method 400.

In some embodiments, the movable platform 10 may include a spraying system 14 provided on the body 11, and the one or more processors 13 of the movable platform 10 is configured to control the spraying system 14 to spray a spray. The spraying system 14 may include a storage tank 15 for storing the spray and a sensor 16 provided in the storage tank 15, and the sensor 16 is configured to detect the remaining amount of the spray in the storage tank 15. In one embodiment, the spraying system 14 further includes a spraying mechanism 17 arranged at one end of an arm 18 away from the body 11, and the spraying mechanism 17 is communicated with the storage tank 15 to spray the spray to realize automated agricultural operations.

As shown in FIG. 8, in some embodiments, the movable platform 10 may include a computer-readable storage medium 19, which may store a program that can be called by the one or more processors 13, and may include a non-volatile storage medium. In some embodiments, the movable platform 10 may include a memory 20 and an interface 21. In some embodiments, the movable platform 10 may also include other hardware depending on an actual application.

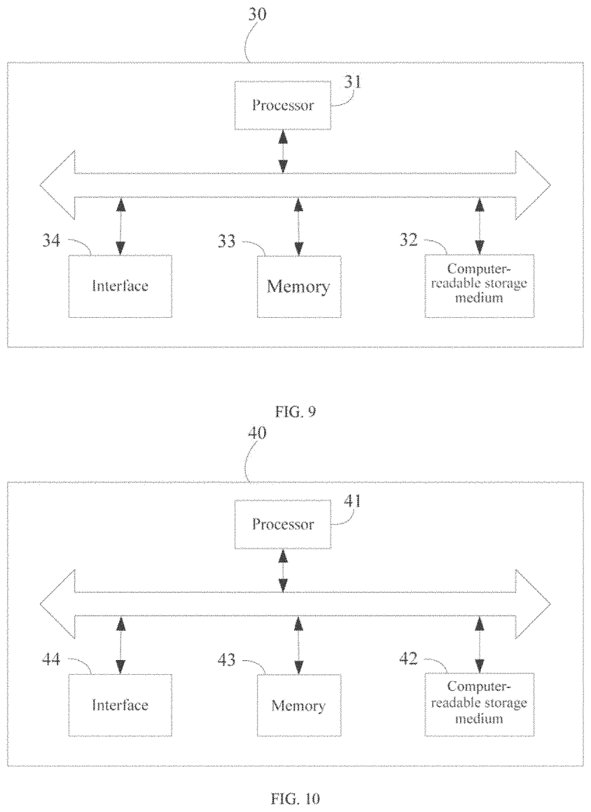

FIG. 9 illustrates a block diagram of a control terminal 30 according to some embodiments of the present disclosure. In an embodiment, the control terminal 30 may include one or more processors 31 configured to implement the control method 200. In another embodiment, the control terminal 30 may include one or more processors 31 configured to implement the control method 300.

In some embodiments, the control terminal 30 may include a computer-readable storage medium 32, which may store a program that can be called by the one or more processors 31, and may include a non-volatile storage medium. In some embodiments, the control terminal 30 may include a memory 33 and an interface 34. In some embodiments, the control terminal 30 may also include other hardware according to actual applications.

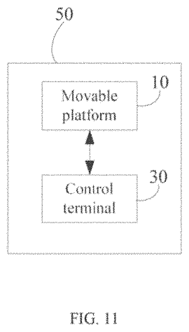

FIG. 10 illustrates a block diagram of a control device 40 according to some embodiments of the present disclosure. In one embodiment, the control device 40 may include one or more processors 41 configured to implement the control method 500. In another embodiment, the control device 40 may include one or more processors 41 configured to implement the control method 600.

In some embodiments, the control device 40 may further include a computer-readable storage medium 42, and the computer-readable storage medium 42 may store a program thereon that can be called by the one or more processors 41, and may include a non-volatile storage medium. In some embodiments, the control device 40 may include a memory 43 and an interface 44. In some embodiments, the control device 40 may also include other hardware according to actual applications.

FIG. 11 illustrates a block diagram of a control system 50 according to an embodiment of the present disclosure. In one embodiment, the control system 50 may include the movable platform 10 shown in FIGS. 7 and 8. The one or more processors 13 of the movable platform 10 is configured to implement the control method 100. The control system 50 may further include the control terminal 30 shown in FIG. 9, the control terminal 30 is configured to communicate with the movable platform 10. The one or more processors 31 of the control terminal 30 is configured to implement the control method 200.

In another embodiment, the one or more processors 13 of the movable platform 10 of the control system 50 is configured to implement the control method 400. In addition, the one or more processors 31 of the control terminal 30 of the control system 50 is configured to implement the control method 300.

The computer-readable storage medium of some embodiments of the present disclosure has a program stored thereon, and when the program is executed by one or more processors, the control method 100 and/or the control method 200 are implemented.

The computer-readable storage medium of some other embodiments of the present disclosure has a program stored thereon, and when the program is executed by one or more processors, the control method 300 and/or the control method 400 are implemented.

Each part of the present disclosure may be implemented by hardware, software or a combination thereof. In the above exemplary embodiments, multiple steps or methods may be implemented by hardware or software stored in a memory and executed by a suitable instruction execution system. For example, if it is realized by hardware, it may be realized by any one of the following technologies or a combination thereof: discrete logic circuits with logic gates for realizing logic functions on data signals, and dedicated integrated circuits with suitable combinational logic gate circuits, a programmable gate array (PGA), a field programmable gate array (FPGA), etc.

The computer readable storage medium may be a tangible device that can store programs and instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random-access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the device/systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

The processor may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

The memory and non-volatile storage medium may be computer-readable storage media. The memory may include any suitable volatile storage devices such as dynamic random access memory (DRAM) and static random access memory (SRAM). The non-volatile storage medium may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

The interface may allow for input and output of data with other devices that may be connected locally with device/systems disclosed herein. For example, the interface may provide a connection to external devices. The external devices may include devices such as a keyboard, a mouse, a keypad, a touch screen, and/or other suitable input devices. The external devices may also include portable computer-readable storage media such as, for example, thumb drives, portable optical or magnetic disks, and memory cards. Software and data used to practice embodiments of the present disclosure, for example, a program, may be stored on such portable computer-readable storage media. The interface may use an industry standard connection, such as RS-232 or Universal Serial Bus (USB), to connect with external devices.

The program may be a collection of machine-readable instructions and/or data that is stored in non-volatile storage medium and is used to create, manage and control certain software functions that are discussed in detail elsewhere in the present disclosure and illustrated in the drawings. In some embodiments, the memory may be considerably faster than the non-volatile storage medium. In such embodiments, the program may be transferred from the non-volatile storage medium to the memory prior to execution by a processor.

The movable platform, control terminal, control device and control system disclosed the present disclosure may be capable of communicating and interacting with each other and other devices via a network through a network interface. The network may be, for example, a local area network (LAN), a wide area network (WAN) such as the Internet, or a combination of the two, and may include wired, wireless, or fiber optic connections. In general, the network can be any combination of connections and protocols that support communications between two or more devices and related devices.

Those skilled in the art will appreciate that all or parts of the steps disclosed in the methods, devices and systems of the instant disclosure may be implemented by instructing the relevant hardware through a program, and the program may be stored in a computer-readable storage medium. When the program is executed, it includes one or a combination of the steps of the method embodiments disclosed herein.

It should be noted that in the instant disclosure, relational terms such as “first” and “second”, etc. are used herein merely to distinguish one entity or operation from another entity or operation without necessarily requiring or implying any such actual relationship or order between such entities or operations. The terms “comprise/comprising”, “include/including”, “has/have/having” or any other variants thereof are intended to cover non-exclusive inclusion, so that a process, method, article or device that includes a series of elements includes not only those elements, but also other elements that are not explicitly listed, or also includes elements inherent to such processes, methods, articles, or equipment. If there are no more restrictions, the element defined by the phrase, such as “comprising a . . . ”, “including a . . . ” does not exclude the presence of additional identical elements in the process, method, article, or equipment that includes the element.

Finally, it should be noted that the above embodiments/examples are only used to illustrate the technical features of the present disclosure, not to limit them; although the present disclosure has been described in detail with reference to the foregoing embodiments and examples, those of ordinary skill in the art should understand that: the technical features disclosed in the foregoing embodiments and examples can still be modified, some or all of the technical features can be equivalently replaced, but, these modifications or replacements do not deviate from the spirit and scope of the disclosure.

What is claimed is:

1. A control method for a movable platform, comprising:
acquiring a planned path of the movable platform, wherein the planned path is a route guiding movement of the movable platform;
controlling the movable platform to move according to the planned path;
obtaining a remaining amount of a consumable of the movable platform;
determining a required replenishment position of the movable platform on the planned path where the remaining amount of the consumable decreases to a remaining amount threshold based on the remaining amount of the consumable; and
acquiring a target replenishment position for replenishing the consumable to the movable platform based on the required replenishment position.

2. The control method according to claim 1, wherein the determining the required replenishment position of the movable platform on the planned path where the remaining amount of the consumable decreases to the remaining amount threshold based on the remaining amount of the consumable comprises:
determining the required replenishment position based on at least a current remaining amount of the consumable and the remaining amount threshold.

3. The control method according to claim 2, wherein the required replenishment position is determined further based on a unit consumption rate, wherein the unit consumption rate is a reduction amount of the consumable per unit area or per unit mileage.

4. The control method according to claim 3, wherein the determining the required replenishment position based on at least the current remaining amount of the consumable, the remaining amount threshold, and the unit consumption rate comprises:
determining a distance that the movable platform moves until the current remaining amount of the consumable decreases to the remaining amount threshold based on at least the current remaining amount of the consumable, the remaining amount threshold and the unit consumption rate; and
determining a position reached by the movable platform moving the distance from a current position on the planned path; and
setting the position as the required replenishment position.

5. The control method according to claim 3, wherein the consumable comprises a spray; and the determining the required replenishment position based on at least the current remaining amount of the consumable, the remaining amount threshold and the unit consumption rate comprises:
determining the required replenishment position based on a current remaining amount of the spray, the remaining amount threshold, a unit area consumption rate, and a spray width.

6. The control method according to claim 3, wherein the consumable comprises at least one of a battery power and a fuel for providing power energy to the movable platform; and the determining the required replenishment position based on at least the current remaining amount of the consumable, the remaining amount threshold, and the unit consumption rate comprises:
determining the required replenishment position based on the current remaining amount of the consumable, the remaining amount threshold, and a unit mileage consumption rate.

7. The control method according to claim 1, wherein the obtaining the remaining amount of the consumable of the movable platform and determining the required replenishment position of the movable platform on the planned path where the remaining amount of the consumable decreases to the remaining amount threshold based on the remaining amount of the consumable comprises:
obtaining the remaining amount of the consumable in real time during the movement of the movable platform; and
determining the required replenishment position in real time based on the remaining amount of the consumable obtained in real time.

8. The control method according to claim 1, wherein there are a plurality of consumables; and the control method comprises:
determining required replenishment positions of the movable platform corresponding to the plurality of consumables on the planned path where remaining amounts of the plurality of the consumables decrease to corresponding remaining amount thresholds, respectively; and
determining the target replenishment position based on at least one of the required replenishment positions corresponding to the plurality of the consumables.

9. The control method according to claim 8, wherein the determining the target replenishment position based on at least one of the replenishment positions corresponding to the plurality of the consumable comprises:
determining corresponding target replenishment positions based on the required replenishment positions corresponding to the plurality of the consumables; or
determining a nearest required replenishment position that is closest to a current position of the movable platform on the planned path among the required replenishment positions corresponding to the plurality of the consumables; and
determining the target replenishment position based on the nearest required replenishment position.

10. The control method according to claim 8, wherein the plurality of the consumables comprise at least two of a spray, a battery power, and a fuel; and the determining the corresponding required replenishment positions of the movable platform on the planned path corresponding to the plurality of consumables where the remaining amounts of the plurality of the consumables decrease to the corresponding remaining amount thresholds comprises:
determining the corresponding required replenishment positions of the movable platform on the planned path where at least two of a remaining amount of the spray, a remaining amount of the battery power, and a remaining amount of the fuel decrease to the corresponding remaining amount thresholds, respectively.

11. The control method according to claim 1, further comprising:
sending information of the target replenishment position to a control terminal;
acquiring a feedback signal generated by the control terminal based on the information of the target replenishment position; and
in a case that the feedback signal indicates that the movable platform is allowed to move to the target replenishment position, controlling the movable platform to move to the target replenishment position when the movable platform reaches the required replenishment position.

12. The control method according to claim 9, further comprising:
sending information of the plurality of the target replenishment positions to a control terminal;
acquiring a feedback signal generated by the control terminal based on the information of the plurality of the target replenishment positions; and
in a case that the feedback signal indicates that one of the plurality of the target replenishment positions is selected, controlling the movable platform to move to the selected target replenishment position when the movable platform reaches the required replenishment position.

13. The control method according to claim 1, further comprising:
controlling the movable platform to move to the target replenishment position when the movable platform reaches the required replenishment position.

14. The control method according to claim 13, further comprising:
controlling the movable platform to continue operations after the consumable is replenished to the movable platform.

15. The control method according to claim 1, wherein the acquiring the target replenishment position for replenishing the consumable to the movable platform based on the required replenishment position comprises:
determining the target replenishment position from a plurality of replenishment positions based on distances from each of the replenishment positions to the required replenishment position.

16. The control method according to claim 1, wherein the acquiring the target replenishment position for replenishing the consumable to the movable platform based on the required replenishment position comprises:
determining an area where a distance from the area to the required replenishment position is less than a distance threshold as a replenishment area; and
determining the target replenishment position in the replenishment area.

17. The control method according to claim 1, wherein the acquiring the planned path of the movable platform comprises:
acquiring the planned path of the movable platform sent by a control terminal.

18. The control method according to claim 1, wherein the acquiring the target replenishment position for replenishing consumable to the movable platform based on the required replenishment position comprises:
acquiring the target replenishment position determined by a control terminal based on the required replenishment position; or
controlling the movable platform to determine the target replenishment position based on the required replenishment position.

19. A control method of a movable platform, comprising:
acquiring a planned path for a movable platform by a control terminal, wherein the planned path is a route guiding movement of the movable platform;
sending the planned path to the movable platform so that the movable platform moves according to the planned path; and
acquiring a required replenishment position and a target replenishment position, wherein the required replenishment position is a position of the movable platform on the planned path where a remaining amount of a consumable of the movable platform decreases to a remaining amount threshold, and the target replenishment position is a position for replenishing the consumable to the movable platform.

20. A control method of a movable platform, comprising:
controlling a control terminal to acquire a planned path for a movable platform, wherein the planned path is a route guiding movement of the movable platform;
controlling the control terminal to send the planned path to the movable platform so that the movable platform moves according to the planned path;
controlling the movable platform to obtain the planned path of the movable platform;
controlling the movable platform to move according to the planned path;
controlling the movable platform to acquire a remaining amount of a consumable of the movable platform and determine a required replenishment position of the movable platform on the planned path where the remaining amount of the consumable decreases to a remaining amount threshold based on the remaining amount of the consumable;
controlling the movable platform to obtain a target replenishment position for replenishing the consumable to the movable platform based on the required replenishment position and send the required replenishment position and the target replenishment position to the control terminal; and
controlling the control terminal to obtain the required replenishment position and the target replenishment position.
